(19) United States
(12) Patent Application Publication
(10) Pub. No.: US 2013/0136568 A1
(43) Pub. Date: May 30, 2013

(54) HANDLING MECHANISM

(71) Applicant: WEN-SHENG CHEN, Shenzhen City (CN)

(72) Inventor: WEN-SHENG CHEN, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD, Shenzhen City (CN)

(21) Appl. No.: 13/443,202

(22) Filed: Apr. 10, 2012

(30) Foreign Application Priority Data
Nov. 24, 2011 (CN) 201110378238.4

(51) Int. Cl. B65G 47/90; B65G 25/06

(52) U.S. Cl. 414/591

(57) ABSTRACT

A handling mechanism comprises a mounting seat, a driving assembly, a sliding member, an extending mechanism and a clamping assembly. The driving assembly is mounted on the mounting seat. The sliding member is slidably mounted on the mounting seat and driven by the driving assembly. The extending mechanism comprises an extending member and a strength member. The extending member is positioned on the sliding member being capable of moving along a direction perpendicular to a direction of the movement of the mounting seat. The strength member is slidably positioned on the sliding member and connects with the extending member. The clamping assembly is fixed to the strength member for clamping very heavy workpieces.

### TECHNICAL FIELD

The present disclosure relates to handling mechanisms, and more particularly, to a handling mechanism used for conveying workpieces.

### DESCRIPTION OF RELATED ART

Handling mechanisms are used for conveying workpieces and materials during mechanical manufacturing. One handling mechanism includes a mounting seat, a driving assembly mounted on the mounting seat, and a sliding member driven by the driving assembly. However, the sliding member is merely capable of sliding relative to the mounting seat along one direction. In addition, a clamping assembly of the handling mechanism is easily distorted or even destroyed because of a heavy load being carried in one end thereof.

Therefore, there is room for improvement in the art.

### BRIEF DESCRIPTION OF THE DRAWINGS

The components in the drawings are not necessarily drawn to scale, the emphasis instead placed upon clearly illustrating the principles of the present disclosure. Moreover, in the drawings, like reference numerals designate corresponding parts throughout the several views.

FIG. 1 is an isometric view of an embodiment of a handling mechanism.

FIG. 2 is an exploded, isometric view of the handling mechanism of FIG. 1 including a sliding member and an extending assembly.

FIG. 3 is an enlarged, exploded isometric view of the sliding member and the extending assembly of FIG. 2.

FIG. 4 is similar to FIG. 2, but viewed from another aspect.

### DETAILED DESCRIPTION

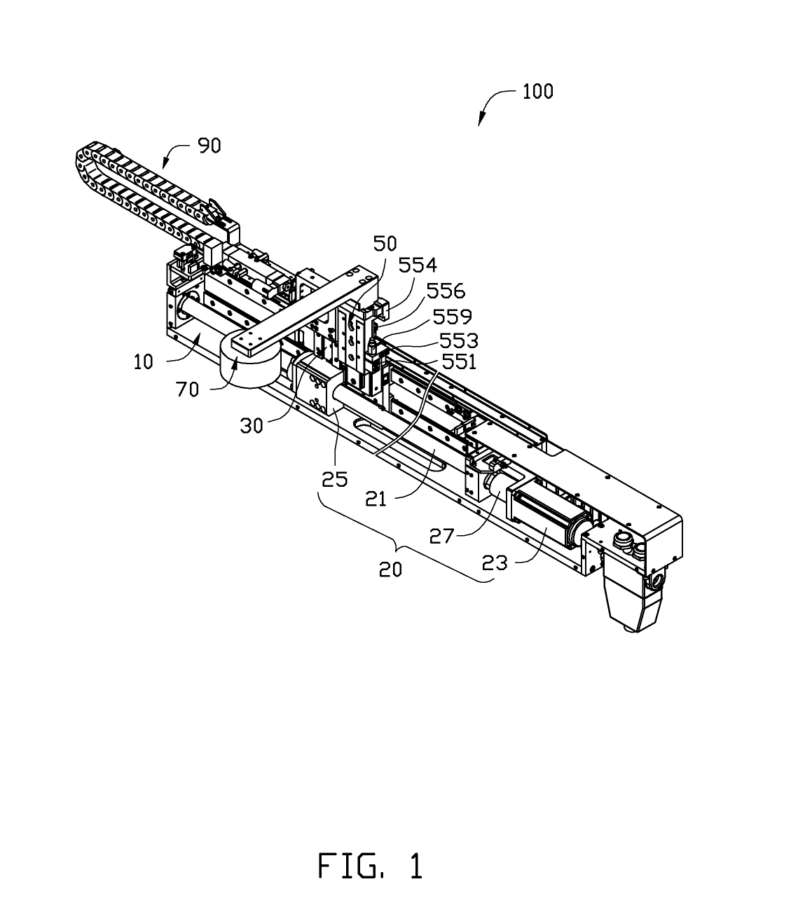

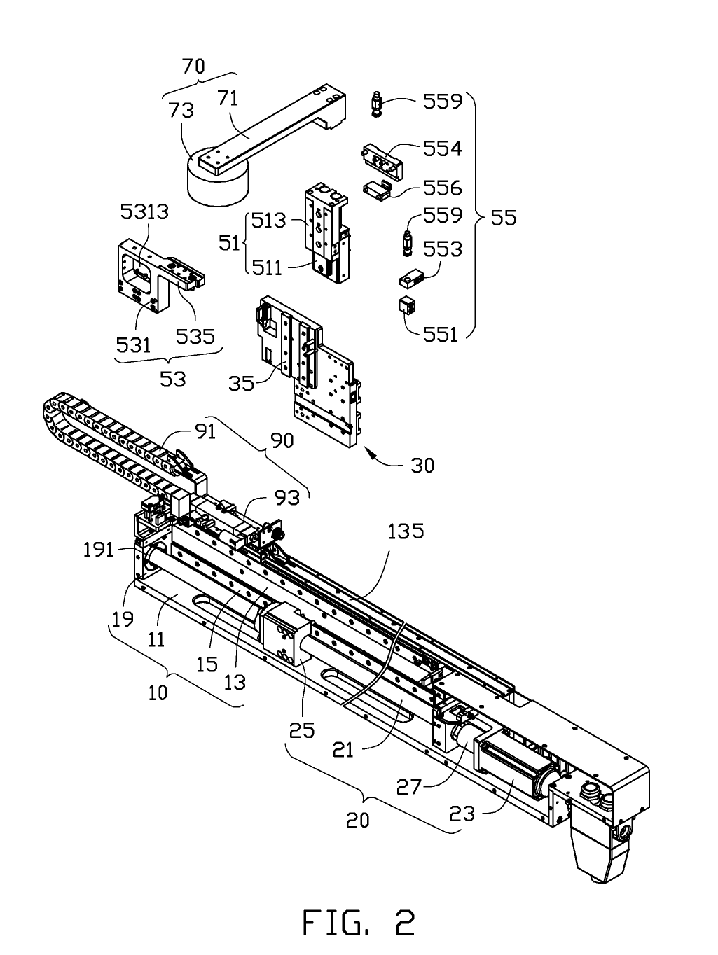

Referring to FIGS. 1 and 2, a handling mechanism 100 includes a mounting seat 10, a driving assembly 20, a sliding member 30, an extending assembly 50 assembled with the sliding member 30, and a clamping assembly 70. The driving assembly 20 is mounted on the mounting seat 10; the sliding member 30 is slidably mounted on the mounting seat 10 and driven by the driving assembly 20. The extending assembly 50 is installed on the sliding member 30 for supporting the clamping assembly 70. The clamping assembly 70 is fixed to the extending assembly 50 to clamp the workpieces (not shown).

The mounting seat 10 is a bar of material, including a bottom board 11, a supporting board 13 extending perpendicularly from one edge of the bottom board 11, and a pair of first guiding rails 15 fixed on the supporting board 13 along the longitudinal direction thereof. The pair of guiding rails 15 are parallel to and spaced from each other. The mounting seat 10 further includes two supporting bases 19 oppositely and separately positioned on the bottom board 11 and connecting to the supporting board 13. One mounting hole 191 is defined in each supporting base 19. In the illustrated embodiment, the supporting board 13 and the bottom board 11 are made integrally. A leading groove 135 is formed in one side end surface of the supporting board 13 away from the bottom board 11.

The driving assembly 20 includes a lead screw 21, a driver 23, a nut 25, and a shaft joint 27. The lead screw 21 passes through the mounting hole 191 and is located between the two supporting bases 19 along the longitudinal direction of the mounting seat 10. The lead screw 21 is substantially parallel to and spaced from the pair of guiding rails 15. The driver 23 is mounted on an end of the lead screw 21 and capable of rotating the lead screw 21. The nut 25 is sleeved on the lead screw 21 and capable of moving along the longitudinal direction of the lead screw 21 when the lead screw 21 rotates. The shaft joint 27 connects the lead screw 21 and the driver 23.

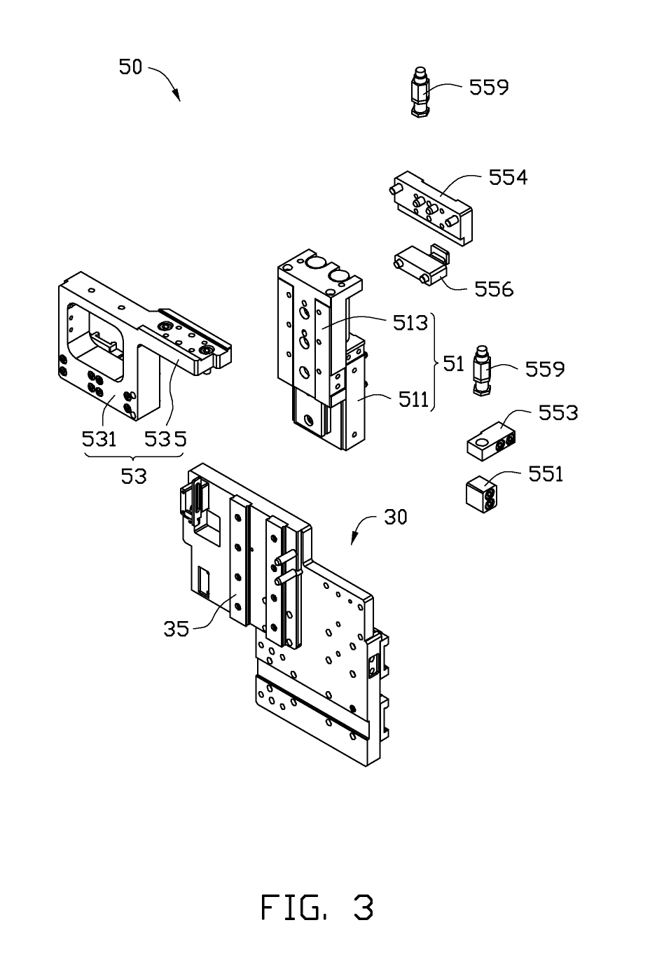

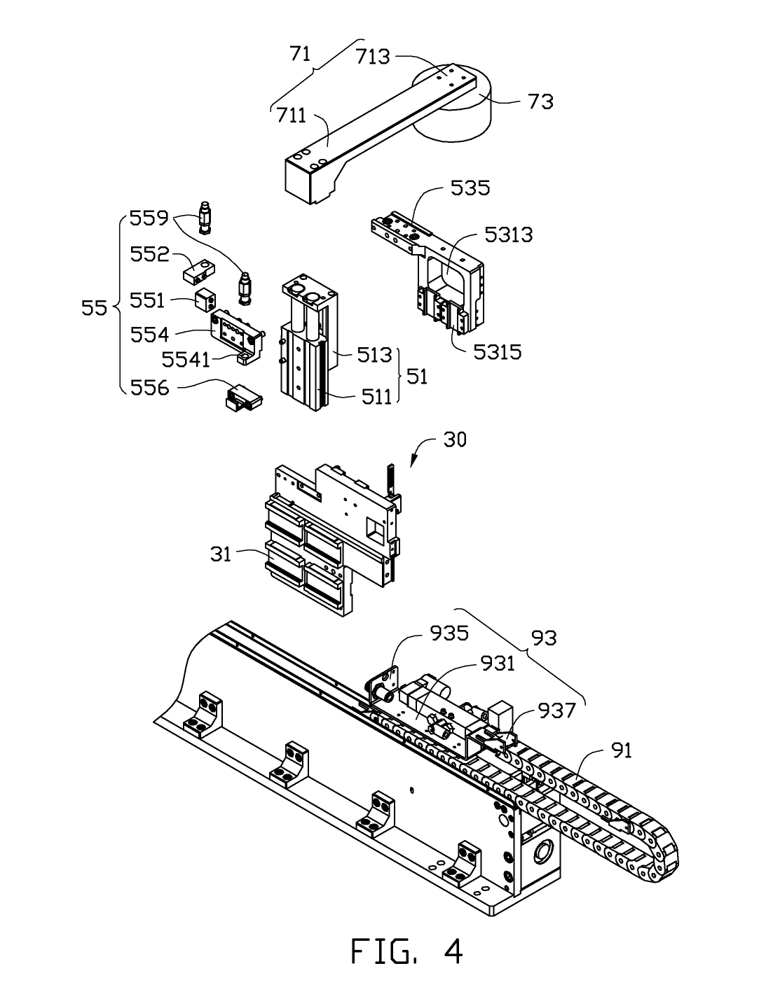

Also referring to FIGS. 3 and 4, the sliding member 30 slidably engages with the pair of first guiding rails 15. The sliding member 30 defines a pair of first guiding grooves 31 corresponding to the pair of first guiding rails 15. The first guiding grooves 31 are substantially parallel to each other. Two second guiding rails 35 are formed at a side of the sliding member 30 opposite to the first guiding grooves 31 thereof. The longitudinal direction of the second guiding rails 35 is perpendicular to that of the pair of first guiding grooves 31. In other embodiments, the number of the first guiding rails 15 may be one or more, and the number of the second guiding rails 35 will change accordingly.

The extending mechanism 50 is mounted on the sliding member 30, and includes an extending member 51, a strength member 53 and an adjustment assembly 55. The extending member 51 is mounted on the sliding member 30 adjacent to the second guiding rails 35. The extending member 51 includes a basing body 511 and an extending portion 513 connecting with the basing body 511. The basing body 511 is installed on the sliding member 30. The extending portion 513 is positioned at one end of the basing body 511 away from the bottom board 11 and capable of moving relative to the basing body 511 in a perpendicular manner relative to the first guiding rails 15.

The strength member 53 is slidably mounted on the second guiding rails 35, and connected with one end of the extending portion 513 away from the basing body 511. The strength member 53 is driven by the extending portion 513 to strengthen the structural support under the workpiece. The strength member 53 includes a main body 531 and a fixing portion 535 extending out of one end of the main body 531. A through hole 5313 is defined through the main body 531 for weight reduction. Two second guiding grooves 5315 are formed in the main body 531 to cooperate with the two second guiding rails 35. The fixing portion 535 is fixed to an end surface of the extending portion 513 away from the basing body 511.

The adjustment assembly 55 includes a first mounting block 551, a second mounting block 553, a third mounting block 554, a fourth mounting block 556 and a pair of adjustment members 559. The first mounting block 551 is mounted on one sidewall of the extending portion 513 away from the strength member 53. The second mounting block 553 is fixed on the basing body 511, and extends out above the first mounting block 551. The third mounting block 554 is mounted on the fixing portion 535. An ear 5541 is positioned on a corner of the third mounting block 554. The fourth mounting block 556 corresponding to the ear 5541 is mounted on the side of sliding member 30 for installing the first guiding rails 15. One adjustment member 559 passes through the second mounting block 553 to resist the first mounting block 551. Another adjustment member 559 passes through the ear 5541 to resist the fourth mounting block 556. Lengths of the adjustment members 559 can be adjusted according the stroke of the extending member 51.

The clamping assembly 70 is fixed to the fixing portion 535. The clamping assembly 70 includes a support plate 71 and a clamping member 73 connected to an end of the support plate 71. The support plate 71 is in an “L” shape, and includes a fixing end 711 and a support end 713 perpendicular to the fixing end 711. The fixing end 711 is fixed to the fixing portion 535. The support end 713 extends away from the strength member 53 and has a length greater than that of the fixing end 711. The clamping member 73 is fixed to an end portion of the support end 713 for clamping a workpiece.

The handling mechanism 100 further includes a cable protecting mechanism 90 for protecting the cables (not shown) received in the cable protecting mechanism 90 and avoiding any intertwining or crushing of the cables. The cable protecting mechanism 90 includes a chain 91 and a connecting member 93. Part of the chain 91 is received in the leading groove 135, and one end of the chain 91 is fixed to an inner wall of the leading groove 135. The connecting member 93 includes a bottom wall 931, a first end wall 935 and a second end wall 937 extending perpendicularly from two opposite ends of the bottom wall 931. The first end wall 935 is connected with the sliding member 30. The second end wall 937 connects to another end of the chain 91 away from the end fixed to the inner wall of the guiding groove 135.

In assembly, the driving assembly 20 is mounted on the mounting seat 10, the sliding member 30 is slidably mounted on the first guiding rails 15 and cooperates with the lead screw 21. The extending member 51 is positioned on the sliding member 30. The strength member 53 is slidably mounted on the second guiding rails 35, and the fixing portion 535 is fixed to the extending portion 513. The adjustment assembly 55 is assembled with the extending member 51, the sliding member 30 and the fixing portion 535. The clamping assembly 70 is installed on the fixing portion 535. The cable protecting mechanism 90 is positioned on the mounting seat 10 and connected with the sliding member 30. The cables are received in the cable protecting mechanism 90.

In use, the driver 23 drives the lead screw 21 to rotate, and the nut 25 drives the sliding member 30 to slide along the pair of first guiding rails 15 until the sliding member 30 approaches a preset position. The extending portion 513 drives the support plate 71 to move. The strength member 53 is also driven to move along the pair of second guiding rails 35. The support end 713 drives the clamping member 73 to move along a direction perpendicular to the bottom board 11. Then the clamping member 73 clamps a workpiece. The connecting member 93 is driven to move along the leading groove 135 by the strength member 53.

The sliding member 30 is capable of sliding along the pair of first guiding rails 15, the extending portion 513 moves perpendicularly to the first guiding rails 15, thus the clamping assembly 70 as fixed to the strength member 53 connecting with the extending portion 513 is capable of moving in two perpendicular directions relative to the mounting seat 10. In adopting such components as described, the handling mechanism 100 is simple and cost is decreased. The handling mechanism 100 is very narrow and can be received in an receiving space, such that the entire occupied volume of the handling mechanism 100 is thereby smaller. In addition, the strength member 53 connecting with the extending portion 513 is driven to slide along the two second guiding rails 35 for added support.

While various embodiments have been described and illustrated, the disclosure is not to be construed as being limited thereto. Various modifications can be made to the embodiments by those skilled in the art without departing from the true spirit and scope of the disclosure as defined by the appended claims.

What is claimed is:

1. A handling mechanism configured for conveying one or more workpieces, comprising:
a mounting seat,
a driving assembly mounted on the mounting seat;
a sliding member slidably mounted on the mounting seat and driven by the driving assembly,
an extending mechanism comprising:
an extending member mounted on the sliding member and being capable of moving along a direction perpendicular to a direction of the movement of the mounting seat;
a strength member slidably positioned on the sliding member and connecting with the extending member; and
a clamping assembly fixed to the strength member for clamping the workpieces.

2. The handling mechanism of claim 1, wherein the mounting seat comprises at least one first guiding rail arranged on the mounting seat thereof, the sliding member defines at least one first guiding groove thereof, the at least one first guiding rail is received in the at least one first guiding groove respectively to enable the sliding member slidably engaging with the mounting seat.

3. The handling mechanism of claim 2, wherein the sliding member comprises at least one second guiding rail at a side of the sliding member opposite to the first guiding groove, the longitudinal direction of the at least one second guiding rail is perpendicular to that of the at least one first guiding groove.

4. The handling mechanism of claim 3, wherein the strength member defines at least one second guiding groove thereof, the at least one second guiding rail is received in the at least one second guiding groove respectively to enable the strength member slidably engages with the sliding member.

5. The handling mechanism of claim 3, wherein the strength member comprises a main body and a fixing portion extending out of one end of the main body, the main body is slidably mounted on the at least one second guiding rails, the fixing portion is fixed to the extending member and connects the clamping assembly.

6. The handling mechanism of claim 1, wherein the extending member comprises a basing body and an extending portion, the basing body is positioned on the sliding member, the extending portion connects with the basing body and moves relative to the basing body perpendicularly to the direction of the movement of the sliding member, the strength member connects with the extending portion.

7. The handling mechanism of claim 6, wherein the extending mechanism further comprises an adjustment assembly, the adjustment assembly comprises a first mounting block, a second mounting block and one adjustment member, the first mounting block is mounted on one sidewall of the extending portion, the second mounting block is fixed on the basing body, the adjustment member passes through the second mounting block to resist the first mounting block.

8. The handling mechanism of claim 7, wherein the extending mechanism further comprises a third mounting block, a fourth mounting block and another adjustment member, the third mounting block is mounted on the strength member adjacent to the extending member, the fourth mounting block is positioned on the sliding member away from the driving member, the another adjustment member passes through the third mounting block to resist the fourth mounting block.

9. The handling mechanism of claim 1, wherein the clamping assembly further comprises a support plate and a clamping member connected to an end of the support plate, the support plate comprises a fixing end and a support end perpendicular to the fixing end, the fixing end is perpendicularly fixed to the strength member, the support end extends away from the strength member, and the clamping member is fixed to the support end.

10. The handling mechanism of claim 1, wherein the mounting seat comprises a bottom board, a supporting board extending perpendicular from one edge of the bottom board, two supporting bases are positioned at the bottom board separately, the driving assembly is positioned between the two supporting bases and on the bottom board, the sliding member is mounted on the supporting board.

11. The handling mechanism of claim 1, wherein the handling mechanism further comprises a cable protecting mechanism, one end of the cable protecting mechanism connects the mounting seat, another end of the cable protecting mechanism is fixed to the sliding member away from the extending member, the cable protecting mechanism is driven to move by the strength member with a same direction as the sliding member.

12. The handling mechanism of claim 11, wherein the cable protecting mechanism comprises a chain and a connecting member, the chain connects the mounting seat and the connecting member, and the connecting member is fixed to the strength member.

13. The handling mechanism of claim 12, wherein a leading groove is formed in mounting seat away from the driving assembly, and a part of the chain is received in the leading groove.
